(19) United States
(12) Patent Application Publication
(10) Pub. No.: US 2016/0274778 A1
(43) Pub. Date: Sep. 22, 2016

(54) USER INTERFACE EXPOSING CONTENT AT A DIRECT FOCAL POINT

(71) Applicant: ALEXANDER LI, ALBANY, CA (US)

(72) Inventor: ALEXANDER LI, ALBANY, CA (US)

(21) Appl. No.: 14/664,626

(22) Filed: Mar. 20, 2015

(51) Int. Cl. G06F 3/0484; G06F 17/30

(52) U.S. Cl. CPC G06F 3/04847; G06F 17/3053; G06F 17/30554

(57) ABSTRACT

A user interface exposing content at a direct focal point is disclosed herein. In one embodiment, content can be assigned to a plurality of tiles. The tiles can be arranged by placing at least one tile at a center of the user interface. Additional tiles can extend from the at least one tile at the center towards at least one side of the user interface. Each tile extending from the at least one tile at the center can expose less content as they reach the at least one side. The tiles at the center can be replaced by the additional tiles exposing more content as they are rotated towards the center. A number of mechanisms can be used to rotate the tiles backwards and forwards.

### TECHNICAL FIELD

This disclosure generally relates to a user interface, and more particularly, to exposing content on a user interface directly in front focusing a user's attention on a limited set of content.

### BACKGROUND

With increased growth of the Internet and the World Wide Web (WWW), it is common for online users to be bombarded with content, for example, on a retail site products and services can be offered through a number of distributors. Shown in FIG. 1, a prior art interface for displaying content is provided. A user of the retail site can be given content after a search query offering a number of different options, in this example, a series of shirts. The shirts can be displayed through tiles organized into rows and columns. Activation, by clicking, of a tile can provide additional information regarding the shirt including an enhanced view of the shirt.

Nevertheless, viewing options for content has been limited. Displaying objects in rows and columns lacks emphasis on any product or service. Furthermore, a user's tendency to focus directly in front of them leads to missed product or service opportunities. What is needed therefore is a user interface exposing content at a direct focal point.

### BRIEF DESCRIPTION

According to one aspect of the present disclosure, a method for focusing a user's view to limited content within a user interface is provided. The method can include assigning content to a plurality of tiles. In addition, the method can include providing at least one tile at a center of the user interface. The method can also include extending additional tiles beginning at the at least one tile at the center of the user interface towards at least one side of the user interface with each additional tile exposing less content towards the at least one side of the user interface.

According to another aspect of the present disclosure, a computing device is provided. The computing device can include at least one processor and a memory operatively coupled to the processor, the memory storing program instructions that when executed by the processor, causes the processor to perform processes. The processes can include providing at least two tiles at a center of a user interface; and displaying additional tiles starting from the at least two tiles at the center of the user interface towards at least two sides of the user interface.

According to yet another aspect of the present disclosure, a user interface is provided. The user interface includes a generator assigning content to a plurality of tiles and a display staggering the plurality of tiles having at least one tile at a center with additional tiles extending away from the at least one tile at the center with less content exposed as the additional tiles extend away from the center with an exception of at least one tile furthest away from the center.

### BRIEF DESCRIPTION OF DRAWINGS

The novel features believed to be characteristic of the disclosure are set forth in the appended claims. In the descriptions that follow, like parts are marked throughout the specification and drawings with the same numerals, respectively. The drawing FIGURES are not necessarily drawn to scale and certain FIGURES can be shown in exaggerated or generalized form in the interest of clarity and conciseness. The disclosure itself, however, as well as a preferred mode of use, further objectives and advantages thereof, will be best understood by reference to the following detailed description of illustrative embodiments when read in conjunction with the accompanying drawings, wherein:

FIG. 1 is a prior art interface for displaying content;

FIG. 2 is a block diagram of an exemplary computing environment in which one or more of the described embodiments can be implemented in accordance with one aspect of the present disclosure;

FIG. 3 is a flow chart for setting up an illustrative user interface exposing content at a direct focal point in accordance with one aspect of the present disclosure;

FIG. 4 is the illustrative user interface exposing content at the direct focal point in accordance with one aspect of the present disclosure;

FIG. 5 is a flow chart for rotating content in the exemplary user interface exposing content at the direct focal point in accordance with one aspect of the present disclosure; and

FIG. 6 is the illustrative user interface exposing content at the direct focal point having rotated content in accordance with one aspect of the present disclosure.

### DESCRIPTION OF THE DISCLOSURE

The description set forth below in connection with the appended drawings is intended as a description of presently preferred embodiments of the disclosure and is not intended to represent the only forms in which the present disclosure can be constructed and/or utilized. The description sets forth the functions and the sequence of steps for constructing and operating the disclosure in connection with the illustrated embodiments. It is to be understood, however, that the same or equivalent functions and sequences can be accomplished by different embodiments that are also intended to be encompassed within the spirit and scope of this disclosure.

The following includes definitions of selected terms employed herein. The definitions include various examples and/or forms of components that fall within the scope of a term and that can be used for implementation. The examples are not intended to be limiting.

A “bus,” as used herein, refers to an interconnected architecture that is operably connected to other computer components inside a computer or between computers. The bus can transfer data between the computer components. The bus can be a memory bus, a memory controller, a peripheral bus, an external bus, a crossbar switch, and/or a local bus, among others.

“Computer communication,” as used herein, refers to a communication between two or more computing devices (e.g., computer, personal digital assistant, cellular telephone, network device) and can be, for example, a network transfer, a file transfer, an applet transfer, an email, a hypertext transfer protocol (HTTP) transfer, and so on. A computer communication can occur across, for example, a wireless system (e.g., IEEE 802.11), an Ethernet system (e.g., IEEE 802.3), a token ring system (e.g., IEEE 802.5), a local area network (LAN), a wide area network (WAN), a point-to-point system, a circuit switching system, a packet switching system, among others.

A “disk,” as used herein can be, for example, a magnetic disk drive, a solid state disk drive, a floppy disk drive, a tape drive, a Zip drive, a flash memory card, and/or a memory stick. Furthermore, the disk can be a CD-ROM (compact disk ROM), a CD recordable drive (CD-R drive), a CD rewritable drive (CD-RW drive), and/or a digital video ROM drive (DVD ROM). The disk can store an operating system that controls or allocates resources of a computing device.

A “database,” as used herein can refer to table, a set of tables, a set of data stores and/or methods for accessing and/or manipulating those data stores. Some databases can be incorporated with a disk as defined above.

A “memory,” as used herein can include volatile memory and/or non-volatile memory. Non-volatile memory can include, for example, ROM (read only memory), PROM (programmable read only memory), EPROM (erasable PROM), and EEPROM (electrically erasable PROM). Volatile memory can include, for example, RAM (random access memory), synchronous RAM (SRAM), dynamic RAM (DRAM), synchronous DRAM (SDRAM), double data rate SDRAM (DDR SDRAM), and direct RAM bus RAM (DRRAM). The memory can store an operating system that controls or allocates resources of a computing device.

A “module,” as used herein, includes, but is not limited to, non-transitory computer readable medium that stores instructions, instructions in execution on a machine, hardware, firmware, software in execution on a machine, and/or combinations of each to perform a function(s) or an action(s), and/or to cause a function or action from another module, method, and/or system. A module may also include logic, a software controlled microprocessor, a discrete logic circuit, an analog circuit, a digital circuit, a programmed logic device, a memory device containing executing instructions, logic gates, a combination of gates, and/or other circuit components. Multiple modules may be combined into one module and single modules may be distributed among multiple modules.

An “operable connection.” or a connection by which entities are “operably connected,” is one in which signals, physical communications, and/or logical communications can be sent and/or received. An operable connection can include a wireless interface, a physical interface, a data interface, and/or an electrical interface.

A “processor.” as used herein, processes signals and performs general computing and arithmetic functions. Signals processed by the processor can include digital signals, data signals, computer instructions, processor instructions, messages, a bit, a bit stream, or other means that can be received, transmitted and/or detected. Generally, the processor can be a variety of various processors including multiple single and multicore processors and co-processors and other multiple single and multicore processor and co-processor architectures. The processor can include various modules to execute various functions.

A “server”, as used herein, is a computer or program that responds to commands from a client through the Internet or other network. A server program on a computer in a distributed network can handle business logic between users and backend business applications or data bases. Servers can provide transaction management, failure and load balancing. A server can be viewed as part of a three tier application consistent of a front end GUI server such as an HTTP server, an application server and a back end database and transaction server. A server may contain data or program files. The server may connect with databases that are either local or remote from the server.

A “tile”, as used herein, can be information regarding a piece of content. Tiles can be a number of different shapes and sizes and contain content from a variety of source. These sources are not limited to products and services. The content on the images can be text, images, animations, videos, sounds, or a combination thereof. Tiles can be customizable and dynamically updated with content. Tiles can be updated to reflect changes associated with the content either dynamically or statically. Tiles can provide access to the content when actuated, for example, clicking on a tile can lead to a page showing additional information for the content. Applications can also be activated after the tile is actuated.

Generally described, the systems and methods disclosed herein are directed to content provided on a user interface. The user interface exposes content at a direct focal point. In one embodiment, content can be assigned to a plurality of tiles. The tiles can be arranged by placing at least one tile at a center of the user interface. Additional tiles can extend from the at least one tile towards at least one side of the user interface. Each tile extending from the at least one tile at the center can expose less content as they reach the at least one side. The tiles at the center can be replaced by the additional tiles exposing more content as they are rotated towards the center. A number of mechanisms can be used to rotate the content on the tiles backwards and forwards.

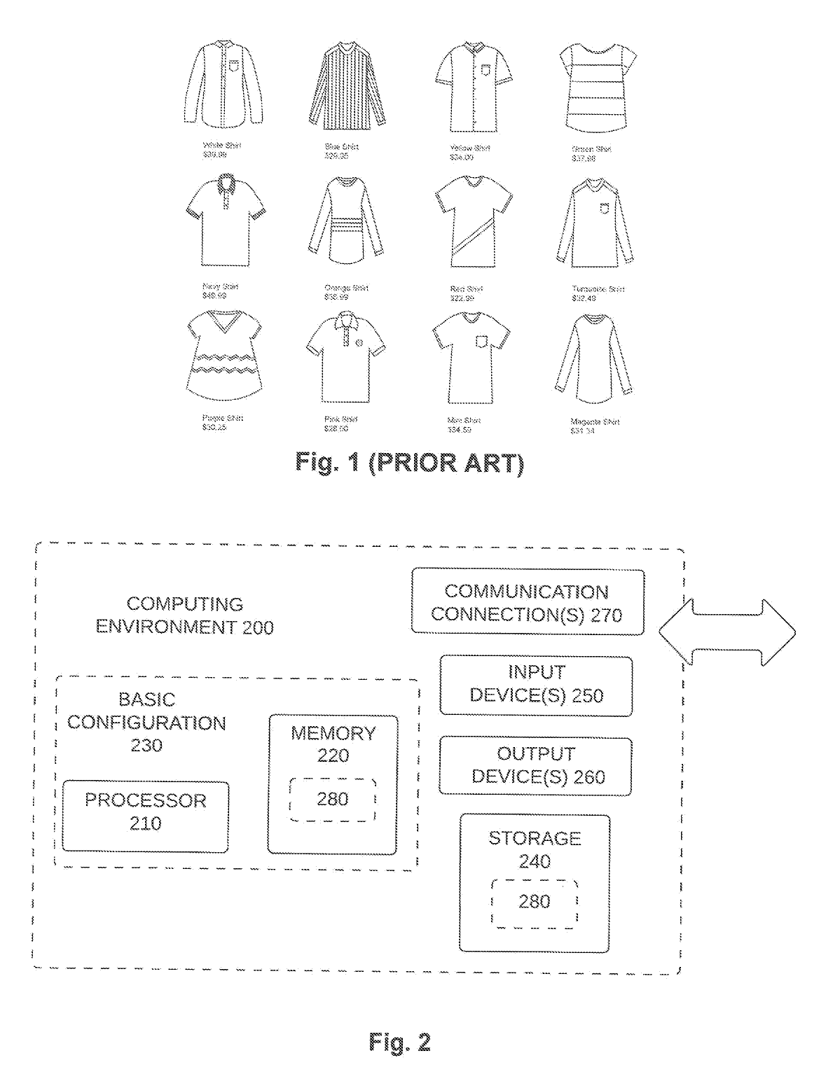

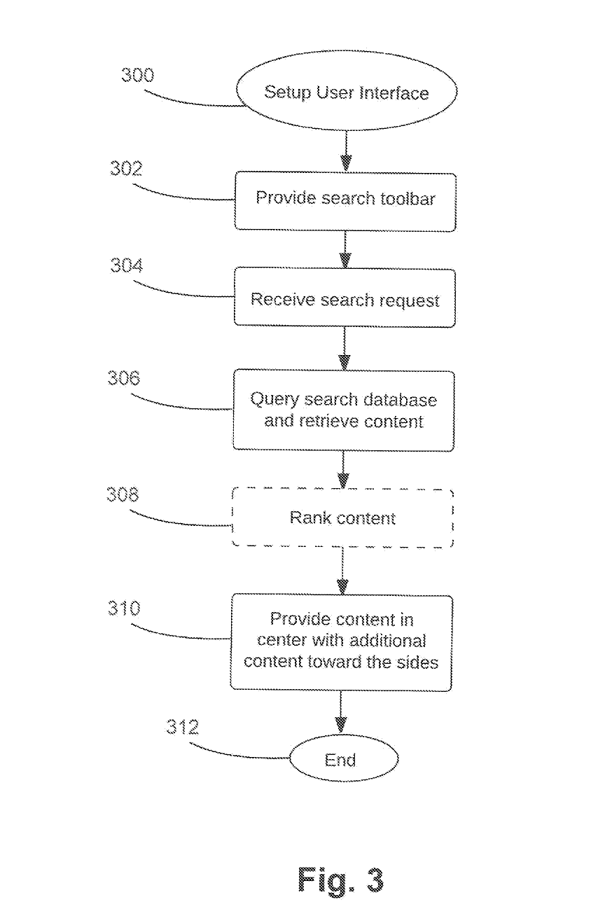

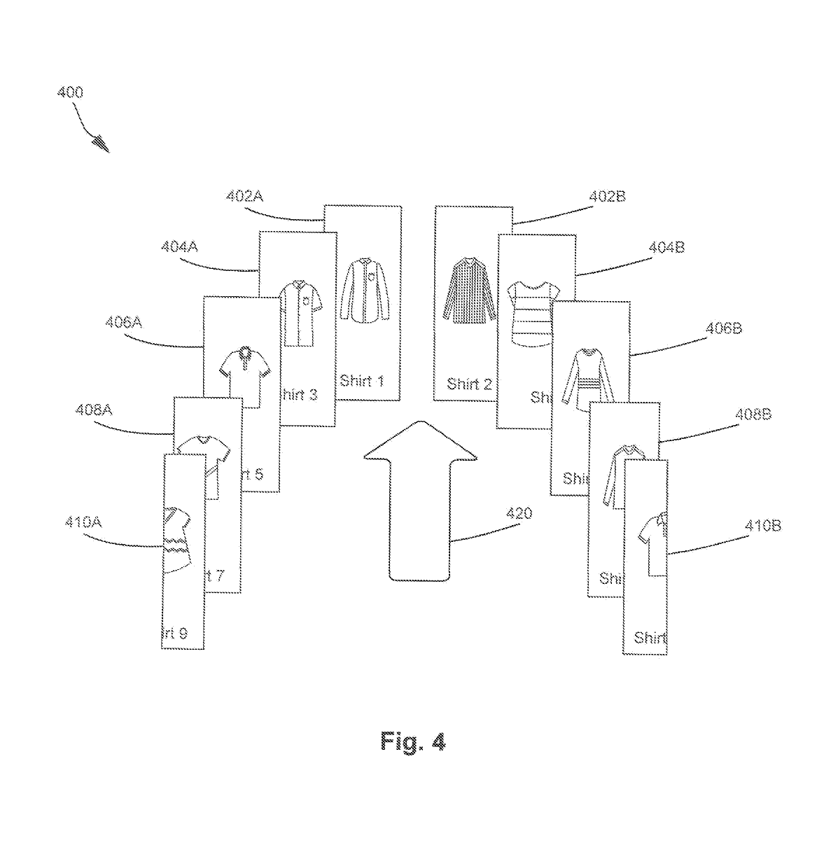

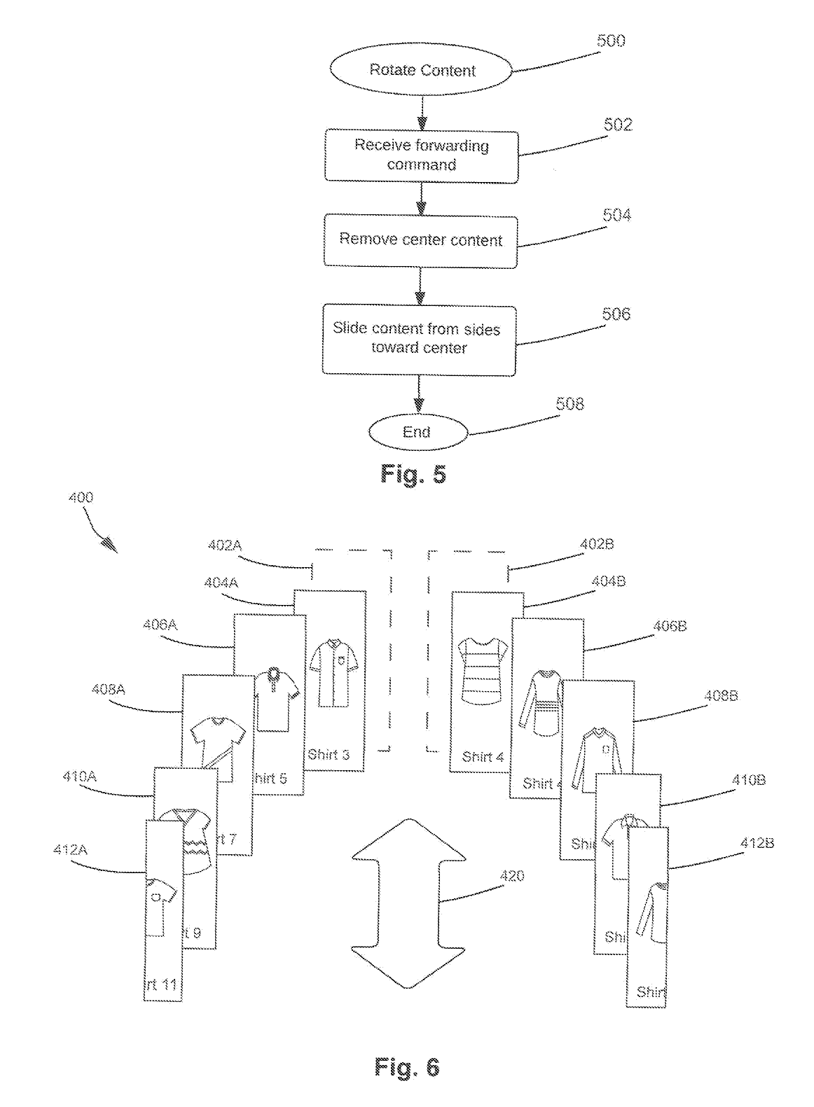

Advantageously, the user interface can direct the user's focus to a set of tiles rather than a larger number of tiles that can be distracting for a user. Furthermore, the interface allows the user to quickly go through a large number of tiles with emphasis on a specific set of tiles at any time while still exposing the user to large amounts of information. Other advantages will become apparent from the description provided below. With reference to the FIGURES, FIG. 1 provided a prior art interface for displaying content. FIG. 2 shows a computing environment for the user interface. FIGS. 3 and 4 describe an initial setup of the user interface while FIGS. 5 and 6 depict rotating the content through the user interface.

FIG. 2 is a block diagram of an exemplary computing environment 200 in which one or more of the described embodiments can be implemented in accordance with one aspect of the present disclosure is provided. The computing environment 200 can be provided on a phone, tablet, laptop, compact disk player, music player, game console, camera, remote control, and the like. Other types of devices which the computing environment 200 can be operable on are also within the scope of the present disclosure. Furthermore, fewer or additional components within the environment 200 can be provided that are not shown.

The computing environment 200 can include at least one processor 210 and memory 220 in a basic configuration 230. The processor 210 can execute computer-executable instructions and can be a real or a virtual processor. In a multi-processing system, multiple processing units execute computer-executable instructions to increase processing power. The memory 220 can be volatile memory (e.g., registers, cache, RAM), non-volatile memory (e.g., ROM, EEPROM, flash memory), or some combination of the two. The memory 220 can store software 280 which can implement application logic for running the user interface of the present disclosure, for example, on a browser.

The computing environment 200 can include a storage 240, one or more input devices 250, one or more output devices 260, and one or more communication connections 270. An interconnection mechanism such as a bus, controller, or network can operably connect the components of the computing environment 200. Typically, operating system software can provide an operating environment for other software executing in the computing environment 200, and can coordinate activities of the components of the computing environment 200.

The storage 240 can be removable or non-removable, and can include computer-readable storage media such as magnetic disks, magnetic tapes or cassettes, CD-ROMs, CD-RWs, DVDs, or any other medium which can be used to store information and which can be accessed within the computing environment 200. The storage 240 can store instructions for the software 280. The input device(s) 250 can be a touch input device such as a keyboard, mouse, pen, or trackball; a voice input device; a scanning device; a network adapter; a CD/DVD reader; or another device that provides input to the computing environment 200. The output device(s) 260 can be a display, printer, speaker, CD/DVD-writer, network adapter, or another device that provides output from the computing environment 200.

The communication connection(s) 270 can enable computer communications over a communication medium to another computing entity. Thus, the computing environment 200 can operate in a networked environment using logical connections to one or more remote computing devices, such as a personal computer, a server, a router, a network PC, a peer device or another common network node. The communication medium conveys information such as data or computer-executable instructions or requests in a modulated data signal. A modulated data signal is a signal that has one or more of its characteristics set or changed in such a manner as to encode information in the signal. By way of example, and not limitation, communication media include wired or wireless techniques implemented with an electrical, optical, RF, infrared, acoustic, or other carrier.

FIG. 3 is a flow chart for setting up an illustrative user interface exposing content at a direct focal point in accordance with one aspect of the present disclosure. The software 280, when executed by the processor, can provide the user interface through a browser or other type of application for display on the output device(s) 260. The processes for setting up the user interface can begin at block 300. While content is retrieved over communication connection(s) 270, as described below, content can also be stored locally on a disk, or the like, and can be accessed to generate tiles for the user interface. Other sources of content are contemplated within the scope of the present disclosure and not limited to those described in the present disclosure.

At block 302, a search toolbar can be provided on the output device(s) 260 of the computing environment 200. The described embodiment contemplates the use of a computing environment 200 for which a browser on an operating system is being executed to locate content over the communication connection(s) 270. The browser 200 can open a connection with a remote server that stores files and content, for example, an online shopping site. In turn, the remote server can provide a web document having the search toolbar.

A search request can be received at block 304 through the search toolbar provided on the web document. Different input device(s) 250 can be used to provide search criteria. For example, keyboards can be used to enter in text to search for specific content. A mouse can be used to provide search terms, possibly through clickable icons. In one embodiment, a series of questions and answer tiles can be used to locate content. The search request can be used to obtain content remotely though the communication connection(s) 270. Alternatively, content can be searched locally. Continuing with the online retailer described above, a search term, such as “shirt”, can be entered into the search toolbar through the input device(s) 250.

At block 306, the computing environment 200 can provide the query search to a remote or local database and retrieve appropriate content based on the search. Continuing with the example of the online retailer provided above, when “shirt” has been entered and sent to the search engine through the communication connection(s) 270, content can be delivered from the online retailer back to the browser. Content received from server of the online retailer can come in a variety of forms, for example, ranked and unranked which is shown in optional block 308. Ranking content can be performed in a variety of methods. The content can be ranked according to relevancy remotely or locally within the computing environment 200. Content can be ranked through other methods such as date the content was created, author who created the content, file types, learning algorithms, historical searches, and the like.

At block 310, the user interface through the computing environment 200 is established. After assigning content to tiles, the tiles can be arranged to expose the content so that focus for the user is directed in front of them. In one embodiment, the content is provided at the center with additional content distributed towards the sides of the user interface. While tiles are described throughout the present disclosure, other indicators can be used, for example, panes or windows. The staggered content, as will be shown below, emphasizes the content at the center by reducing the amount of content seen on tiles near the sides of the user interface. The processes can end at block 312.

Above, the processes of obtaining content and generating tiles were associated with an online retailer. This should not be construed as limiting, for example, content can be obtained with other types of websites. Furthermore, content can be obtained from local storage on a computing device with the arrangement of the content similar to the pattern described above. Also, the content can be associated with an operating system showing applications, or other types of functionalities. FIG. 4 is the illustrative user interface 400 exposing content at the direct focal point in accordance with one aspect of the present disclosure. The user interface 400 provides the assigned content on a plurality of tiles by displaying at least one tile 402A and 402B at a center of the user interface 400 and extending additional tiles 404A, 404B, 406A, 406B, 408A, 408B, 410A, and 410B beginning at the at least one tile 402A and 402B at the center of the user interface 400 towards at least one side of the user interface 400 with each additional tile 404A, 404B, 406A, 406B, 408A, 408B, 410A, and 410B exposing less content towards the at least one side of the user interface 400.

While the tiles 402A, 402B, 404A, 404B, 406A, 406B, 408A, 408B, 410A, and 410B are displayed within the user interface 400 through staggering them from a center portion to a bottom corner, other variations can be implemented and are within the scope of the present disclosure. For example, the tiles can shift directly from center to left and right portions of the user interface 400. Organization of the tiles can be dependent on the amount of tiles that the user wishes to display on their output device(s) 260, however, the user interface 400 exposes the most content on the center tiles 402A and 402B with those tiles 404A, 404B, 406A, 406B, 408A, 408B, 410A, and 410B away from the center exposing less content.

In one embodiment of the user interface 400, fewer or more center tiles can be provided. For example, one tile can be provided at the center of the user interface 400 with additional tiles staggered therefrom. Four center tiles can also be provided within the center with additional tiles extending to each of the corners of the user interface 400.

Exposing less content with the additional tiles 404A, 404B, 406A, 406B, 408A, 408B, 410A, and 410B will now be described. The center tiles 402A and 402B of the user interface 400, as shown, can be fully exposed or almost fully exposed. Typically, the highest ranked content at startup can be shown at the center tiles 402A and 402B. Tiles 404A and 404B can be placed on top of tiles 402A and 402B. However, these tiles 404A and 404B display less of a surface area than tiles 402A and 402B exposing less content seen by a user as they are covered by tiles 406A and 4060.

Continuing, tiles 406A and 406B, placed on top of tiles 404A and 404B expose less content than tiles 402A, 402B, 404A and 404B. The pattern of the user interface 400 can thus be described as exposing less content as additional tiles are placed on one another. Tiles 408A and 408B are placed on top of tiles 406A and 406B and tiles 410A and 410B are placed on top of 408A and 408B. Additional tiles can be placed on top of those tiles with even less content being exposed and the number of shown tiles should not be construed as limiting.

The end tiles 410A and 410B, in one embodiment, can be fully exposed or as shown in the user interface 400 of FIG. 4, cut off similar to the other additional tiles. The cut off can result from the application or program that provides the user interface 400. By arranging or staggering the tiles, the user's focus is directly in front of them.

Provided within the user interface 400 is an actuator 420. The actuator 420 can be used to rotate or shift the tiles 402A, 402B, 404A, 404B, 406A, 406B, 408A, 408B. 410A, and 410B. By pressing, or clicking the actuator 420, the tiles 402A, 402B, 404A, 404B, 406A, 406B, 408A, 408B, 410A, and 410B can be moved forwards or backwards depending on where the actuator 420 is pressed. In one embodiment, the backwards portions of the actuator 420 can be removed, not shown, at startup or when there are not tiles to be brought back. Pressing on the forward portion of the actuator 420 can move the tiles towards the center which will be shown below.

The shown actuator 420 can move two tiles at the same time. However, the user interface 400 can include additional or alternative actuators for manipulating the tiles. For example, separate actuators for each side can be given such that one side is manipulated with that given actuator. The purpose of the shown interface 400 is to expose two tiles 402A and 402B simultaneously for a user's view. Typically, the content placed on each of the tiles 402A, 402B, 404A, 404B, 406A, 406B, 408A. 408B, 410.4, and 410B is different. When the content has been rotated and no additional content is available, tiles are not replaced at the end.

In one embodiment, a single tile 402A, 402B, 404A, 404B, 406A, 406B, 408A, 408B, 410A, or 410B can be activated by a user click on their mouse, or through some other actuation technique. When activated the tile can be brought to the center and enlarged such that the tile can be viewed more closely. Drag and drop techniques can also be provided where a user can drag the tile 402A, 402B, 404A, 404B, 406A, 406B, 408A, 408B, 410A, or 410B out to expose additional content on the tile. The tile can be brought back into the staggered formation through deactivation techniques such as clicking on a certain area within the tile itself. Drag and drop techniques can be used as well.

FIG. 5 is a flow chart for rotating content in the exemplary user interface 400 exposing content at the direct focal point in accordance with one aspect of the present disclosure. The processes can begin at block 500. At block 502, a forwarding command can be provided through the actuator 420. Other methods, described above, can be used to rotate the tiles, for example, an actuator for sliding one set of tiles can be implemented.

At block 504, the center tiles 402A and 402B of the user interface 400 are removed when the actuator 420 is activated or clicked. The content from the additional tiles 404A, 404B, 406A, 406B, 408A, 408B, 410A, and 410B can then be shifted towards the center of the user interface 400. Additional tiles 412A and 412B can be created and placed at the sides of the user interface 400. These new tiles 412A and 412B can be generated from the remaining content used from the search presented earlier or other content that is available. When the tiles 404A, 4048, 406A, 406B, 408A, 408B, 410A, and 410B are shifted towards the center of the user interface 400, more content is exposed on each of them. The processes can end at block 508.

In one embodiment, a learning element can be used to generate the new tiles that are to be added. The learning element can use the previously removed center tiles 402A and 402B as indicators of content that the user does not want to view. For example, if the user has a tendency to remove “blue shirts” then future additional tiles are not to show blue shirts. A number of different learning elements can be provided to provide the new tiles.

FIG. 6 is the illustrative user interface 400 exposing content at the direct focal point having rotated content in accordance with one aspect of the present disclosure. After activation of the actuator 420 in the forward direction, the center tiles 402A and 402B can be removed. In one embodiment, removal of the tiles 402A and 402B can cause the computing environment 200 to generate an animation highlighting the removal of the tiles 402A and 402B. Special effects can be provided when the tiles 402A and 402B are removed such as slow disappearing actions, fly outs, break aways, or some other effect, as indicated by the dotted lines.

As shown, tiles 404A, 404B, 406A, 406B, 408A, 408B, 410A, and 410B have been shifted towards the center with each tile exposing more content. For example, tiles 406A and 406B depict additional tile space than what was previously shown. In addition, tiles 404A and 404B have been placed in the center slot with full, or almost full, exposure. Replacing the center tiles 402A and 402B can be newly created tiles 412A and 412B.

The actuator 420 can provide a backwards arrow to indicate that a reverse mode is available. When activated, the actuator 420 can reverse the tiles 404A, 404B, 406A. 406B, 408A, 408B, 410A, and 410B with tiles 412A and 412B being removed and tiles 402A and 402B being recovered for the user interface 400. The tiles 404A, 404B, 406A, 406B, 408A, 408B, 410A, and 410B can be rotated towards the sides of the user interface 400.

While shown as a single forward and backwards rotation, additional forward or reverse rotations can be made and those shown are for illustrative purposes. The user interface 400 can forward the tiles as long as there are generated tiles. Reversing can occur as long as there are tiles to be brought back. Typically, the removed tiles are stored on the remote server, but can be stored locally as well.

While the tiles described above where shown to start from a center portion and staggered towards bottom sides of the user interface 400, other configurations can be provided and are within the scope of the present disclosure. For example, the center tiles 402A and 402B can be provided on the bottom of the user interface 400 with the additional tiles 404A, 404B, 406A, 406B, 408A, 408B, 410A, and 410B extending towards at least one bottom side of the user interface 400. The tile 404A, 404B, 406A, 406B, 408A, 408B, 410A, and 410B can also extend upwards.

The data structures and code, in which the present disclosure can be implemented, can typically be stored on a non-transitory computer-readable storage medium. The storage can be any device or medium that can store code and/or data for use by a computer system. The non-transitory computer-readable storage medium includes, but is not limited to, volatile memory, non-volatile memory, magnetic and optical storage devices such as disk drives, magnetic tape, CDs (compact discs), DVDs (digital versatile discs or digital video discs), or other media capable of storing code and/or data now known or later developed.

The methods and processes described in the disclosure can be embodied as code and/or data, which can be stored in a non-transitory computer-readable storage medium as described above. When a computer system reads and executes the code and/or data stored on the non-transitory computer-readable storage medium, the computer system performs the methods and processes embodied as data structures and code and stored within the non-transitory computer-readable storage medium. Furthermore, the methods and processes described can be included in hardware modules. For example, the hardware modules can include, but are not limited to, application-specific integrated circuit (ASIC) chips, field-programmable gate arrays (FPGAs), and other programmable-logic devices now known or later developed. When the hardware modules are activated, the hardware modules perform the methods and processes included within the hardware modules.

The technology described herein can be implemented as logical operations and/or modules. The logical operations can be implemented as a sequence of processor-implemented executed steps and as interconnected machine or circuit modules. Likewise, the descriptions of various component modules can be provided in terms of operations executed or effected by the modules. The resulting implementation is a matter of choice, dependent on the performance requirements of the underlying system implementing the described technology. Accordingly, the logical operations making up the embodiment of the technology described herein are referred to variously as operations, steps, objects, or modules. It should be understood that logical operations can be performed in any order, unless explicitly claimed otherwise or a specific order is inherently necessitated by the claim language.

Various embodiments of the present disclosure can be programmed using an object-oriented programming language, such as SmallTalk, Java, C++, Ada or C#. Other object-oriented programming languages can also be used. Alternatively, functional, scripting, and/or logical programming languages can be used. Various aspects of this disclosure can be implemented in a non-programmed environment, for example, documents created in HTML, XML, or other format that, when viewed in a window of a browser program, render aspects of a GUI or perform other functions. Various aspects of the disclosure can be implemented as programmed or non-programmed elements, or any combination thereof.

The foregoing description is provided to enable any person skilled in the relevant art to practice the various embodiments described herein. Various modifications to these embodiments will be readily apparent to those skilled in the relevant art, and generic principles defined herein can be applied to other embodiments. Thus, the claims are not intended to be limited to the embodiments shown and described herein, but are to be accorded the full scope consistent with the language of the claims, wherein reference to an element in the singular is not intended to mean “one and only one” unless specifically stated, but rather “one or more.” All structural and functional equivalents to the elements of the various embodiments described throughout this disclosure that are known or later come to be known to those of ordinary skill in the relevant art are expressly incorporated herein by reference and intended to be encompassed by the claims. Moreover, nothing disclosed herein is intended to be dedicated to the public regardless of whether such disclosure is explicitly recited in the claims.

What is claimed is:

1. A method for focusing a user's view to limited content within a user interface comprising:
assigning content to a plurality of tiles;
providing at least one tile at a center of the user interface; and
extending additional tiles beginning at the at least one tile at the center of the user interface towards at least one side of the user interface with each additional tile exposing less content towards the at least one side of the user interface.

2. The method of claim 1, wherein assigning the content to the plurality of tiles comprises performing a search query and allocating the content to the plurality of tiles based on a highest rated content from the search query.

3. The method of claim 2, wherein allocating the content to the plurality of tiles based on the highest rated content from the search query comprises placing the highest rated content on the at least one tile at the center of the user interface and less rated content on the additional tiles towards the at least one side of the user interface.

4. The method of claim 1, wherein assigning the content to the plurality of tiles comprises gathering an image and written information of the content and placing the image and written information on a tile.

5. The method of claim 1, wherein providing the at least one tile at the center of the user interface comprises displaying a fully exposed tile.

6. The method of claim 1, wherein providing the at least one tile at the center of the user interface comprises displaying the at least one tile at a bottom center of the user interface with the additional tiles extending towards at least one bottom side of the user interface.

7. The method of claim 1, comprising:
removing the at least one tile at the center of the user interface;
rotating the additional tiles towards the center of the user interface; and
adding at least one new tile at the at least one side of the user interface.

8. The method of claim 7, wherein removing the at least one tile at the center of the user interface comprises providing animation highlighting the at least one tile.

9. The method of claim 7, wherein rotating the additional tiles towards the center of the user interface and adding at least one new tile at the at least one side of the user interface comprises exposing more content on the tiles.

10. The method of claim 7, comprising:
recovering the at least one tile at the center of the user interface;
rotating the additional tiles towards the at least one side of the user interface; and
removing the at least one new tile at the at least one side of the user interface.

11. A computing device comprising:
at least one processor; and
a memory operatively coupled to the processor, the memory storing program instructions that when executed by the processor, causes the processor to:
provide at least two tiles at a center of a user interface; and
display additional tiles starting from the at least two tiles at the center of the user interface towards at least two sides of the user interface.

12. The computing device of claim 11, wherein displaying the additional tiles starting from the at least two tiles at the center of the user interface towards the at least two sides of the interface comprises staggering the additional tiles showing less tile as the additional tiles approach the at least two sides of the user interface.

13. The computing device of claim 12, wherein tiles at the at least two sides of the interface are fully exposed.

14. The computing device of claim 11, wherein the memory storing program instructions, when executed by the processor, causes the processor to display a controller for rotating through the tiles on the user interface.

15. The computing device of claim 14, wherein the controller rotates the tiles backwards and forwards.

16. A user interface comprising:
a generator assigning content to a plurality of tiles; and
a display staggering the plurality of tiles having at least one tile at a center with additional tiles extending away from the at least one tile at the center with less content exposed as the additional tiles extend away from the center with an exception of at least one tile furthest away from the center.

17. The user interface of claim 16, wherein the at least one tile at the center is removed and replaced by at least one tile from the additional tiles.

18. The user interface of claim 17, wherein a new tile is generated and added as part of the additional tiles.

19. The user interface of claim 18, wherein the new tile is assigned content through a learning element.

20. The user interface of claim 16, comprising: an actuator maneuvering through the tiles.
